(19) United States
(12) Patent Application Publication
(10) Pub. No.: US 2015/0060312 A1
(43) Pub. Date: Mar. 5, 2015

(54) Beta-Phosphorylated Nitroxide Radicals as Inhibitors for Reactive Resins, Reactive Resins Containing Said Beta-Phosphorylated Nitroxide Radicals and Use of Said Beta-Phosphorylated Nitroxide Radicals

(71) Applicant: Hilti Aktiengesellschaft, Schaan (LI)

(72) Inventors: Thomas Buergel, Landsberg (DE); Armin Pfeil, Kaufering (DE)

(73) Assignee: Hilti Aktiengesellschaft, Schaan (LI)

(21) Appl. No.: 14/395,288

(22) PCT Filed: Apr. 10, 2013
(86) PCT No.: PCT/EP2013/057425

§ 371 Date: Oct. 17, 2014

(30) Foreign Application Priority Data
Apr. 20, 2012 (DE) 10 2012 206 568.7

(51) Int. Cl. C07F 9/32; C08L 71/00; B65D 25/08; C08L 33/14

(52) U.S. Cl. CPC C07F 9/3205; C08L 33/14; C08L 71/00; B65D 25/08
USPC 206/219; 525/123; 525/149; 524/507; 524/508; 524/4; 524/6

(57) ABSTRACT

Use of a β-phosphorylated nitroxide radical as an inhibitor for resin mixtures and reactive resin mortars, each based on radically curable compounds. The pot life of mortar compounds can be adjusted in a targeted manner with the β-phosphorylated nitroxide radical for resin mixtures and reactive resin mortars.

This application claims the priority of International Application No. PCT/EP2013/057429, filed Apr. 10, 2013, and German Patent Document No. 10 2012 206 554.7, filed Apr. 20, 2012, the disclosures of which are expressly incorporated by reference herein.

### DESCRIPTION

The present invention relates to the use of a β-phosphorylated nitroxide radical as an inhibitor to adjust the pot life of resin mixtures and reactive resin mortars, each based on radically curable compounds. Furthermore, the present invention relates to a reactive resin mixture containing this inhibitor and a reactive resin mortar produced from same, each based on radically curable compounds as well as their use as binders for the chemical fastening technique.

The use of reactive resin mortars based on radical curable compounds as binders has long been known. In the field of fastening technology, resin mixtures have been successfully used as organic binders for chemical fastening technology, for example, as dowel compositions. These are composite materials, which are fabricated as multicomponent systems, wherein one component, i.e., the A component, contains the resin mixture and the other component, the B component, contains the curing agent. Vinyl ester resins and unsaturated polyester resins are often used as radically curable compounds, in particular for the chemical fastening technology. Other conventional ingredients such as organic or inorganic additives, for example, fillers, accelerators, stabilizers, inhibitors, thixotropy agents, stabilizing agents, thickeners and solvents, including reactive solvents (reactive diluents) and dyes may be present in one and/or the other component. Then by mixing the two components, the curing reaction, i.e., polymerization is initiated by formation of free radicals and the resin is cured to form the thermosetting plastic.

For a targeted use, it is important in the meantime to delay the polymerization reaction to the extent that the mixture still remains processable for a certain amount of time, also known as the pot life or gel time, after the resin component has been mixed with the hardener component, so that the mixture can be introduced into a borehole, for example, and a fastening means can be introduced before the mixture begins to cure (to polymerize). This is achieved by adding compounds, i.e., the so-called inhibitors, that are capable of capturing the free radicals formed when the two components are mixed, i.e., the so-called inhibitors. In order for the pot life, which is adjusted for a given system, to also remain stable for a longer period of time after storage of the resin component, the inhibitor effect should not change during storage due to autoxidation of the compounds, for example, or due to influences involving the system, so that there is no unwanted change in the curing properties of the mixture.

In order for compounds to be suitable as inhibitors for resin mixtures and reactive resin mortars, they must meet different criteria, such as the influence on the efficiency of the cured resin composition as well as the adjustability of the pot life to a predetermined reasonable extent. In addition, the inhibitor must be stable with respect to the alkaline reacting additives when the resin components still contains a hydraulically setting or polycondensable inorganic compound such as cement in addition to the reactive resin.

For stabilization against premature polymerization, resin mixtures and reactive resin mortars usually contain suitable amounts of phenolic compounds as stabilizers, such as hydroquinone, substituted hydroquinones, phenothiazine, benzoquinone or tert-butylpyrocatechol, as described in EP 1935860 A1 or EP 0965619 A1, for example. These stabilizers impart to the reactive resin mortar a stability of several months in storage, but this is usually only in the presence of oxygen dissolved in the reactive resin mortar. If these reactive resin mortars are stored in the absence of air, polymerization begins after only a few days. For this reason, it has been necessary in the past to package these reactive resin mortars in such a way that they come in contact with air. Some of these stabilizers can also be used in particular as inhibitors to adjust the pot life in pre-accelerated reactive resin mixtures. However, this requires the inhibitors to be used in amounts that depend on the desired pot life of up to 5000 ppm or even more.

These phenolic compounds, especially those which are particularly suitable as inhibitors for premature polymerization of the reactive resin mixtures because of their reactivity, have the disadvantage that they are deactivated by atmospheric oxygen, in particular in the presence of alkaline media, i.e., alkaline additives or fillers, for example, which results in the fact that during storage of a system inhibited in this way, the pot life drops to unacceptably short times. This is where we also speak of unwanted gel time drift.

To prevent such a gel time drift, DE 19531649 A1 proposes that the phenolic compounds should be replaced by the free radicals piperidinyl-N-oxyl and tetrahydropyrrole-N-oxyl. Therefore, 4-hydroxy-2,2,6,6-tetramethylpiperidin-N-oxyl (also known as tempol) is currently often used for stabilization, i.e., to increase stability in storage when the reactive resin mortar is stored in the absence of air. Tempol has the advantage that it can be used to adjust the pot life.

However, the present inventors have observed that gel time drift sometimes occurs with resin mixtures and reactive resin mortars that contain acids or traces of acids and whose pot life has been adjusted with tempol to a certain level. Larger amounts of acid in particular may have a negative effect on pot life stability.

The object of the present invention was then to provide reactive resin mixtures having a stable gel time as well as the reactive resin mortars produced therefrom, whose pot life can be adjusted reliably, even after storage of the reactive resin mixture and/or of the reactive resin mortar, even in the presence of acids or traces of acids and additives and fillers that give an alkaline reaction.

This object is achieved by the fact that a β-phosphorylated nitroxide radical is used as an inhibitor, i.e., as an agent to adjust the reactivity and the pot life of resin mixtures or reactive resin mortars containing the same, each based on radically curable compounds.

Meanings used in the sense of the invention:

“Base resin”: The pure curing and/or curable compound, which cures spontaneously by polymerization or with reactive reagents such as hardeners, accelerators, and the like (not present in the base resin); the curable compounds may be monomers, dimers, oligomers, and prepolymers;

“Radically curable compound”: The compound contains functional groups that undergo free radical polymerization;

“Resin masterbatch”: The product of production of the base resin after synthesis (without isolating the base resin), which may contain reactive diluents, stabilizers, and catalysts;

“Resin mixture”: A mixture of the resin masterbatch and accelerators plus stabilizers and optionally additional reactive diluents; this term is used as equivalent to the term “organic binder”;

“Reactive resin mortar”: A mixture of resin mixture and organic and inorganic additives for which the term “A component” is used as equivalent;

“Reactive resin compound”: A ready-to-process curing mixture of a reactive resin mortar with the required curing agent; this term is used as equivalent to the term “mortar compound”;

“Curing agent”: Substances which cause the polymerization (curing) of the base resin;

“Hardener”: A mixture of curing agent(s), optionally stabilizers, solvent(s), and optionally organic and/or inorganic additives; this term is used as equivalent to the term “B component”;

“Reactive diluent”: Liquid or low-viscosity base resins, which dilute other base resins, the resin masterbatch, or the resin mixture and thereby impart the required viscosity to their application, containing functional groups capable of reaction with the base resin and becoming a predominant part of the cured compound (mortar) in the polymerization (curing);

“Accelerator”: A compound capable of accelerating the polymerization reaction (curing), which serves to accelerate the formation of the radical initiator;

“Stabilizer”: A compound capable of inhibiting the polymerization reaction (curing), which serves to prevent the polymerization reaction and thus to prevent unwanted premature polymerization of the radically polymerizable compound during storage; these compounds are usually used in such small amounts that the pot life is not affected;

“Inhibitor”: A compound capable of inhibiting, i.e., retarding, the polymerization reaction (curing), serving to delay the polymerization reaction immediately after addition of the curing agent; these compounds are usually used in amounts such that the pot life is affected; the term “inhibitor” is used as equivalent to the term “means for adjusting the reactivity and the pot life”;

“Pot life” (also “gel time”): In general, refers to the maximum period of time within which a system consisting of multiple components should be processed after mixing; more precisely, this corresponds to the period of time within which the temperature of the reactive resin compound increases from +25° C. to +35° C. after it has been prepared;

“Gel time drift” (for a certain period of time, for example, 30 or 60 days): Refers to the phenomenon whereby, when the curing takes place at a different point in time than the reference standard point in time of curing, for example, 24 hours after preparation of the reactive resin and/or the reactive resin compound, the observed pot life differs from the point in time of the reference.

“Stable gel time”: This means that there is no gel time drift after storage of resin mixtures and/or reactive resin mortars.

Reactive resin mortars are usually prepared by placing the starting compounds required to produce the base resin in a reactor optionally together with catalysts and solvents, in particular reactive diluents, and reacting them. After the end of the reaction and optionally already at the start of the reaction, compounds for the storage stability, namely the stabilizers, are added to the reaction mixture. This yields the so-called resin masterbatch. Accelerators for curing the base resin and compounds for adjusting the pot life, the inhibitors and optionally other solvents, in particular reactive diluents, are optionally added to the resin masterbatch to obtain the resin mixture. As mentioned above, the compounds for storage stability (stabilizers) may be the same as or different from the compounds for adjusting the pot life (inhibitors). This resin mixture is combined with inorganic additives to adjust various properties, such as the rheology and the concentration of the basic resin, so that the reactive resin mortar, the A component, is obtained. For storage, the reactive resin mortar is poured into glass capsules, cartridges or film bags, which are optionally airtight, depending on the intended application.

Thus a resin mixture preferably contains at least one radically curable compound, reactive diluent, accelerator, stabilizers, and optionally additional inhibitors, to adjust the pot life and a reactive resin mortar in addition to the resin mixture already described, organic and/or inorganic additives, but inorganic additives are especially preferred, as described in greater detail below.

The invention is based on the idea of making available resin mixtures and reactive resin mortars prepared from them, in particular those containing traces of acids and/or inorganic additives and fillers, whose pot life can be adjusted reliably and independently of the duration of storage, without requiring complex and expensive purification of the respective components, such as precursor compounds, e.g., the polymeric methylene diphenyl diisocyanate (pMDI) or the reactive diluents.

The inventors have discovered that the resin mixtures having gel time stability and reactive resin mortars containing the same, in particular those containing traces of acid due to the production process, can be made available if a β-phosphorylated nitroxide radical is used as the inhibitor. The pot life of resin mixtures and reactive resin mortars based on radically curable compounds can be adjusted to a predetermined extent in this way.

The use of β-phosphorylated nitroxide radicals for the production of polymers, copolymers and block copolymers is known from EP 0135820 A2, EP 0906937 A1 and WO 9624620 A1, for example, but compounds of the general composition R′R″N—O—X, which are converted by heating into a radical initiator X, and a compound R′R″N—O, which functions as a chain terminator, or the free radical R′R″N—O. is used directly. However, the unsaturated monomers or comonomers described here are not complex systems in the sense that they contain larger molecules than radically curable compounds, which may optionally also contain traces of acid and, secondly, they are filled with alkaline-reacting inorganic additives.

Inorganic additives, which give a strongly basic reaction, for example, cement are frequently used in systems with inorganic fillers, such as those used as dowel compounds for chemical fastening of anchoring elements, for example. Furthermore, the radically curable compounds are not processed, i.e., isolated but instead the resin masterbatch is used to produce the resin mixtures and the reactive resin mortars.

Those skilled in the art are aware of the fact that the additives contained in the resin masterbatch as well as the additional additives and fillers added to the resin masterbatch can have a substantial influence on the stability of the base resin, i.e., its tendency to premature polymerization without the addition of curing agents during storage. The additives and fillers as well as their concentrations may produce a different effect, which cannot be predicted. The systems must therefore be reevaluated and their properties must be adjusted when one component is replaced by another even if a similar reactivity is to be expected.

A first subject matter of the present invention is the use of a β-phosphorylated nitroxide radical as an inhibitor for a resin mixture or a reactive resin mortar containing the same, each based on radically curable compounds.

The β-phosphorylated nitroxide radicals suitable according to the invention are selected from compounds of general formula (I)

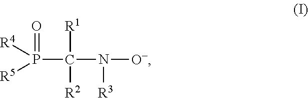

in which R¹ and R² may be the same or different and each denotes a hydrogen atom, a linear, branched or cyclic C₁-C₁₀ alkyl group, an aryl group or a C₁-C₁₀ aralkyl group or R¹ and R² are linked together so that they form a ring with the carbon atom carrying the radicals R¹ and R², also having 3 to 8 carbon atoms including the carbon atom carrying the radicals R¹ and R²; R³ denotes a linear or branched, saturated or unsaturated C₁-C₃₀ hydrocarbon group, optionally containing at least one ring; and R⁴ and R⁵ may be the same or different and each denotes a linear or branched C₁-C₂₀ alkyl, cycloalkyl, aryl, alkoxy, aryloxy, aralkyloxy, perfluoroalkyl, aralkyl, dialkyl or diarylamino, alkylarylamino, or thioalkyl groups; or

R⁴ and R⁵ are linked together so that, together with the phosphorus atom, they form a ring having 2 to 4 carbon atoms and may also contain one or more additional oxygen, sulfur, or nitrogen atoms.

The term “alkyl group” refers to a linear or branched C₁-C₂₀ alkyl group or a C₃-C₂₀ cycloalkyl group such as, for example, a methyl, ethyl, n-propyl, isopropyl, n-butyl, n-dodecanyl, isobutyl, tert-butyl, cyclopropyl, or cyclohexyl group.

The term “aryl group” refers to an aromatic group with 6 to 20 carbon atoms such as, for example, a phenyl, naphthyl, tolyl, or biphenyl group.

The term “aralkyl group” denotes an aryl group, as defined above, which is substituted with at least one alkyl group as defined above such as, for example, a 2-phenylethyl, tert-butylbenzyl, or benzyl group.

The term “dialkylamino group” denotes a group in which the nitrogen atom is bound to at least two alkyl groups as defined above.

The term “diarylamino group” denotes a group in which the nitrogen atom is bound to two aryl groups as defined above.

The term “alkylarylamino group” denotes a group in which the nitrogen atom is bound to an alkyl group as defined above and an aryl group as defined above.

The term “thioalkyl group” denotes a group in which an alkyl group is bound to a sulfur atom as defined above.

The compound of general formula (I) is preferably a compound of the general formula (II)

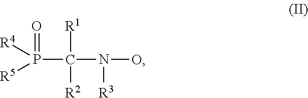

in which R¹ and R³ are defined as given above; R⁴ and R⁵ may be the same or different and denote an alkoxy, aryloxy, or aralkyloxy group.

R¹ and R³ are especially preferably the same or different and denote a branched or cyclic C₄-C₁₀ alkyl group, and R⁴ and R⁵ are the same or different and denote a C₁-C₄ alkoxy group.

R¹ and R³ most especially preferably denote a tert-butyl group, and R⁴ and R⁵ denote an ethoxy group, so that the compound of general formula (II) is 1-(diethoxyphosphinyl)-2,2-dimethyl-propyl-1,1-dimethylmethyl nitroxide.

Synthesis of β-phosphorylated nitroxide radicals is known and has been described, for example, in WO 9624620 A1 and WO 0248159 A1.

Another subject matter of the invention is a resin mixture containing at least one radically curable compound, at least one reactive diluent, optionally a stabilizer to impart storage stability to the resin mixture, and an agent for adjusting the reactivity and the pot life, wherein said agent is a stable β-phosphorylated nitroxide radical as described above.

To adjust the pot life to a predetermined extent, the β-phosphorylated nitroxide radical is used in an amount of 0.1 to 3 wt %, preferably 0.3 to 2 wt %, especially preferably 0.5 to 1.5 wt %, based on the resin mixture.

It will be clear to those skilled in the art that the mechanism of action of the β-phosphorylated nitroxide radical used depends not only on the amount of same used but also on whether an accelerator is used and, if so, in which amount, and in which amount the radical initiator is used. The smaller the amount of accelerator and/or radical initiator, the sooner the β-phosphorylated nitroxide radical will influence the pot life, i.e., at a lower quantity added. However, those skilled in the art can determine the amount of β-phosphorylated nitroxide radical beyond which and to which extent the pot life can be influenced without any great effort for a given system having a known accelerator and initiator concentration.

According to the invention, the resin mixture may also contain, in addition to or instead of the β-phosphorylated nitroxide radicals, other compounds such as hydroquinone, substituted hydroquinones, phenothiazine, benzoquinone, or tert-butylpyrocatechol, which impart stability in storage, to the resin mixture. Such compounds are sufficiently well known and can be selected by those skilled in the art by a suitable method.

In one embodiment, the resin mixture may additionally contain 0.005 to 3 wt %, preferably 0.01 to 1 wt %, based on the resin mixture, of another inhibitor, in particular a phenolic inhibitor, such as phenols, quinones or phenothiazines, e.g., 2,6-di-tert-butyl-p-cresol, but also catechols, such as pyrocatechol and derivatives thereof to adjust the pot life and the reactivity (cf. EP 1 935 860 A1).

According to the invention, ethylenically unsaturated compounds, cyclic monomers, compounds with carbon-carbon triple bonds and thiol-yn/en resins, such as those with which those skilled in the art are familiar, are suitable as radically curable compounds.

Of these compounds, the group of ethylenically unsaturated compounds is preferred, comprising styrene and derivatives thereof, (meth)acrylates, vinyl esters, unsaturated polyesters, vinyl ethers, allyl ethers, itaconates, dicyclopentadiene compounds, and unsaturated fats, of which unsaturated polyester resins and vinyl ester resins are suitable in particular and are described in the patent applications EP 1 935 860 A1, DE 195 31 649 A1, WO 02/051903 A1, and WO 10/108939 A1, for example. Vinyl ester resins are the most preferred because of their hydrolytic stability and excellent mechanical properties.

Examples of suitable unsaturated polyesters that may be used in the resin mixture according to the invention are divided into the following categories, as classified by M. Malik et al. in J. M. S.—Rev. Macromol. Chem. Phys., C40 (2 and 3), pp. 139-165 (2000):

(1) Ortho resins: These are based on phthalic anhydride, maleic anhydride, or fumaric acid and glycols such as 1,2-propylene glycol, ethylene glycol, diethylene glycol, triethylene glycol, 1,3-propylene glycol, dipropylene glycol, tripropylene glycol, neopentyl glycol, or hydrogenated bisphenol A; (2) Iso resins: These are produced from isophthalic acid, maleic anhydride, or fumaric acid, and glycols; these resins may contain larger amounts of reactive diluents than the ortho resins;

(3) Bisphenol A fumarates: These are based on ethoxylated bisphenol A and fumaric acid; (4) HET acid resins (hexachloroendomethylene tetrahydrophthalic acid resins): These are resins produced from anhydrides or phenols that contain chlorine/bromine in the synthesis of unsaturated polyester resins.

In addition to these classes of resins, the so-called dicyclopentadiene resins (DCPD resins) may also be differentiated as unsaturated polyester resins. The class of DCPD resins is obtained either by modification of one of the types of resins listed above by Diels-Alder reaction with cyclopentadiene or as an alternative they may be obtained by a first reaction of a dicarboxylic acid, e.g., maleic acid with dicyclopentadienyl, and then by a second reaction, the standard synthesis process for an unsaturated polyester resin, where the latter is called a DCPD maleate resin.

The unsaturated polyester resin preferably has a molecular weight Mn in the range of 500 to 10,000 Dalton, more preferably in the range of 500 to 5000 and even more preferably in the range of 750 to 4000 (according to ISO 13885-1). The unsaturated polyester resin has an acid value in the range of 0 to 80 mg KOH/g resin, preferably in the range of 5 to 70 mg KOH/g resin (according to ISO 2114-2000). If a DCPD resin is used as an unsaturated polyester resin, the acid value preferably amounts to 0 to 50 mg KOH/g resin.

In the sense of the present invention, vinyl ester resins are oligomers, prepolymers, or polymers having at least one (meth)acrylate terminal group, so-called (meth)acrylate functionalized resins, which also includes urethane (meth)acrylate resins and epoxy (meth)acrylates.

Vinyl ester resins having unsaturated groups only in terminal position, are obtained, for example, by reacting epoxy oligomers or polymers (e.g., bisphenol A digylcidyl ether, epoxies of the phenol-novolac type, or epoxide oligomers based on tetrabromobisphenol A) with, for example, (meth)acrylic acid or (meth)acrylamide. Preferred vinyl ester resins include (meth)acrylate-functionalized resins and resins obtained by reaction of an epoxide oligomer or polymer with methacrylic acid or methacrylamide, preferably with methacrylic acid. Examples of such compounds are known from the patent applications U.S. Pat. No. 3,297,745 A, U.S. Pat. No. 3,772,404 A, U.S. Pat. No. 4,618,658 A, GB Patent 2 217 722 A1, DE 37 44 390 A1, and DE 41 31 457 A1.

Particularly suitable and preferred vinyl ester resins include (meth)acrylate-functionalized resins obtained, for example, by reaction of difunctional and/or higher functional isocyanates with suitable acryl compound, optionally with the participation of hydroxy compounds containing at least two hydroxyl groups, such as those described in DE 3940309 A1, for example.

Isocyanates that can be used include aliphatic (cyclic or linear) and/or aromatic difunctional or higher functional isocyanates and/or prepolymers thereof. Using such compounds increases the wetting capacity and thus improves the adhesion properties. Aromatic difunctional or higher functional isocyanates and/or prepolymers thereof are preferred, an aromatic difunctional or higher functional prepolymers are especially preferred. For example, toluylene diisocyanate (TDI), diisocyanatodiphenylmethane (MDI), and polymeric diisocyanatodiphenylmethane (pMDI) may be mentioned for increasing the chain stiffening and hexane diisocyanate (HDI) and isophorone diisocyanate (IPDI) which improve flexibility can be mentioned, but polymeric diisocyanatodiphenylmethane (pMDI) is most especially preferred.

Suitable acyl compounds include acrylic acid and acrylic acids with substituents on the hydrocarbon moiety such as methacrylic acid, hydroxyl group-containing esters of (meth)acrylic acid with polyvalent alcohols, pentaerythritol tri(meth)acrylate, glycerol di(meth)acrylate such as, for example, trimethylolpropane di(meth)acrylate, neopentyl glycol mono(meth)acrylate. Acrylic and/or methacrylic acid hydroxyalkyl esters such as hydroxyethyl(meth)acrylate, hydroxypropyl(meth)acrylate, polyoxyethylene(meth)acrylate, polyoxypropylene(meth)acrylate especially since such compounds serve to provide stearic hindrance for the saponification reaction.

Suitable hydroxy compounds that may optionally be used include di- or higher valent alcohols such as the derivatives of ethylene and/or propylene oxide such as ethanediol, di- and/or triethylene glycol, propanediol, dipropylene glycol, other diols such as 1,4-butanediol, 1,6-hexanediol, neopentyl glycol, diethanolamine also bisphenol A and/or F and/or their ethoxylation/propoxylation and/or hydrogenation and/or halogenation products, higher valent alcohols such as glycerol, trimethylol propane, hexanetriol and pentaerythritol, polyethers containing hydroxyl groups, for example, oligomers of aliphatic or aromatic oxiranes and/or higher cyclic ethers such as ethylene oxide, propylene oxide, styrene oxide and furan, polyethers containing aromatic structural units in the main chain such as, for example, bisphenol A and/or F, polyesters based on the aforementioned alcohols and/or polyethers containing hydroxyl groups and dicarboxylic acids and/or their anhydrides such as adipic acid, phthalic acid, tetra- and/or hexahydrophthalic acid, HET acid, maleic acid, fumaric acid, itaconic acid, sebacic acid, and the like. Hydroxy compounds with automatic structural units are especially preferred for chain stiffening of the resin, hydroxy compounds containing unsaturated structural units such as fumaric acid to increase the crosslinking density, branched and/or star-shaped hydroxy compounds, in particular tri- and/or higher valent alcohols and/or polyethers and/or polyesters containing their structural units, branched and stellate urethane (meth)acrylates to achieve a lower viscosity of the resins and/or solutions thereof in reactive diluents and with a higher reactivity and crosslinking density.

The vinyl ester resin preferably has molecular weight Mn in the range of 500 to 3000 Dalton, more preferably 500 to 1500 Dalton (according to ISO 13885-1). The vinyl ester resin has an acid value in the range of 0 to 50 mg KOH/g resin, preferably in the range of 0 to 30 mg KOH/g resin (according to ISO 2114-2000).

All these resins that can be used according to the invention may be modified by methods with which those skilled in the art are familiar in order to achieve, for example, lower acid numbers, hydroxide numbers or anhydride numbers or they can be made more flexible by introducing flexible units into the basic structure and the like.

In addition, the resin may also contain other reactive groups that can be polymerized with a radical initiator such as peroxides, for example, reactive groups which are derived from itaconic acid, citraconic acid and allylic groups and the like.

The use of the β-phosphorylated nitroxide radical in a resin mixture, whose curable component contains traces of acid, such as mineral acid or carboxylic acid, is especially suitable, such as those formed in the synthesis of the radically curable compound or a precursor compound thereof, for example.

The base resins are used in an amount of 20 to 100 wt %, preferably 25 to 65 wt %, based on the resin mixture.

In a preferred embodiment of the invention, the resin mixture contains at least one reactive diluent for the curable ingredient (a), wherein the reactive diluent(s) is/are added in an amount of 0 to 80 wt %, preferably 30 to 60 wt %, based on the resin mixture. Suitable reactive diluents are described in EP 1 935 860 A1 and DE 195 31 649 A1.

Fundamentally, other conventional reactive diluents may also be used, either alone or in mixture with (meth)acrylic acid esters, for example, styrene, α-methylstyrene, alkylated styrenes such as tert-butylstyrene, divinylbenzene, vinyl ether, and/or allyl compounds.

According to another preferred embodiment of the invention, the resin mixture is present in a pre-accelerated form; in other words it contains at least one accelerator for the curing agent. Preferred accelerators for the curing agent include aromatic amines and/or salts of cobalt, manganese, tin, vanadium, or cerium. Accelerators that have proven to be especially advantageous include anilines, p- and m-toluidines and xylidines, which may be substituted symmetrically or asymmetrically with alkyl or hydroxyalkyl moieties. For example, the following preferred accelerators can be mentioned: N,N-dimethylaniline, N,N-diethylaniline, N,N-diethylolaniline, N-ethyl-N-ethylolaniline, N,N-diisopropanol-p-toluidine, N,N-diisopropylidene-p-toluidine, N,N-dimethyl-p-toluidine, N,N-diethylol-p-toluidine, N,N-diethylol-m-toluidine, N,N-diisopropylol-m-toluidine, N,N-bis(2-hydroxyethyl)toluidine, N,N-bis(2-hydroxyethyl)xylidine, N-methyl-N-hydroxyethyl-p-toluidine, cobalt octoate, cobalt naphthenate, vanadium(IV) acetylacetonate, and vanadium(V)-acetylacetonate.

According to the invention, the accelerator and/or the accelerator mixture is added in an amount of 0.05 to 5 wt %, preferably 1 to 2 wt %, based on the resin mixture.

The resin mixtures according to the invention may be used to prepare reactive resin mortars for the chemical fastening technology. The reactive resin mortars prepared according to the invention are characterized by a particularly good stability in storage—even in the absence of atmospheric oxygen.

Another subject matter of the invention is therefore a reactive resin mortar which contains the usual inorganic additives such as fillers, thickeners, thixotropy agents, nonreactive solvents, agents to improve flow properties, and/or wetting agents in addition to the resin mixture. The fillers are preferably selected from the group consisting of particles of quartz, quartz sand, corundum, calcium carbonate, calcium sulfate, glass and/or organic polymers of a wide range of sizes and shapes, for example, as sand or powder, in the form of beads or hollow beads but also in the form of fibers of organic polymers such as, for example, polymethyl methacrylate, polyester, polyamide, or in the form of microbeads of polymers (bead polymers). The globular inert substances (spherical shape) are preferred and have a definite strengthening effect.

Suitable thickeners or thixotropy agents include those based on silicates, bentonite, laponite, pyrogenic silica, polyacrylates, and/or polyurethanes.

Another subject matter of the invention is a multicomponent mortar system comprising at least two (spatially) separate components A and B. The multicomponent mortar system comprises two or more separate interconnected and/or interleaved containers, wherein the one, i.e., component A, contains the reactive resin mortar, and the other, i.e., component B, contains the hardener, which may optionally be filled with organic and/or inorganic additives.

The multicomponent mortar system may be present in the form of a capsule or a cartridge or a film bag. When the inventive reactive resin mortars are used as intended, component A and component B are mixed together by being expressed from the capsules or cartridges or from bags, either under the influence of mechanical forces or by gas pressure, preferably with the help of a static mixer, through which the ingredients are passed and introduced into the borehole, after which the devices to be solidified, such as threaded anchor rods or the like are introduced into the borehole that has been charged with the curing reactive resin and then adjusted accordingly.

Preferred hardeners are organic peroxides that are stable in storage. Dibenzoyl peroxide and methyl ethyl ketone peroxide as well as tert-butyl perbenzoate, cyclohexanone peroxide, lauroyl peroxide, and cumene hydroperoxide as well as tert-butylperoxy-2-ethylhexanoate are especially suitable.

The peroxides are used in amounts of 0.2 to 10 wt %, preferably 0.3 to 3 wt %, based on the reactive resin mortar.

In a particularly preferred embodiment of the inventive multicomponent mortar system, the A component also contains, in addition to the curable compounds, a hydraulically setting or polycondensable inorganic compound, in particular cement, and the B component also contains water in addition to the curing agent. Such hybrid mortar systems are described in detail in DE 42 31 161 A1, where the A component preferably contains cement, for example, Portland cement or aluminate cement as the hydraulically setting or polycondensable inorganic compound, wherein cements having little or no iron oxide content are particularly preferred. Gypsum as such or in mixture with cement may also be used as the hydraulically setting inorganic compound.

The A component may also comprise as the polycondensable inorganic compound, silicatic, polycondensable compounds in particular substances containing soluble dissolved and/or amorphous silicon dioxide.

The great advantage of the invention is that it is no longer necessary to inspect the components of the resin composition such as the curable compound or its precursors for traces of acid such as mineral acid or to subject them to an expensive and complex cleaning which may be necessary in some cases. There is a significant increase in the stability of reactive resin mortars during storage in particular.

The following examples are presented to further illustrate the present invention.

### EXEMPLARY EMBODIMENTS

### EXAMPLE 1

688 g hydroxypropyl methacrylate is mixed with 0.5 mL dibutyltin dilaurate. At 60° C., 311 g polymeric methylene diphenyl diisocyanate (pMDI; Desmodur VL R 20®, maximum acidity value: 200 ppm HCl; Bayer) is added slowly by drops, whereupon the internal temperature rises to 85° C. After the end of the dropwise addition, stirring is continued until the residual isocyanate content has dropped to less than 0.2%. To do so, 698 g 1,4-butanediol dimethacrylate as a reactive diluent and 19.9 g N,N-bis(hydroxyethyl)-p-toluidine and 20.4 g 1-(diethoxyphosphinyl)-2,2-dimethylpropyl-1,1-dimethylmethyl nitroxide were added. A free-flowing preparation was prepared by combining with 50 g pyrogenic silica, 340 g alumina cement, and 700 g quartz sand.

To produce the hardener component, 40 g dibenzoyl peroxide, 250 g water, 25 g pyrogenic silica, 5 g laminar silicate, and 700 g quartz powder of a suitable grain size distribution were combined in the dissolver to form a homogeneous composition.

### EXAMPLE 2

622 g of a commercial vinyl ester resin based on bisphenol A was combined with 510 g hydroxyethyl methacrylate and 568 g ethylene glycol dimethacrylate and 19.9 g N,N-bis-(hydroxyethyl)-p-toluidine and 15.3 g 1-(diethoxyphosphinyl)-2,2-dimethylpropyl-1,1-dimethylmethyl nitroxide were added. A pasty composition was prepared by blending with 50 g pyrogenic silica, 340 g alumina cement, and 700 g quartz sand.

### COMPARATIVE EXAMPLE 1 (V1)

For the comparison, a reactive resin mortar according to Example 1 was produced, except that 5.3 g 4-hydroxy-2,2,6,6-tetramethylpiperidin-N-oxyl was used instead of the 20.4 g 1-(diethoxyphosphinyl)-2,2-dimethylpropyl-1,1-dimethylmethyl nitroxide.

### COMPARATIVE EXAMPLE 2 (V2)

As a further comparison, a reactive resin mortar according to Example 3a) was prepared except that 5.4 g 2,6-di-tert-butyl-p-cresol was used instead of the 15.3 g 1-(diethoxyphosphinyl)-2,2-dimethylpropyl-1,1-dimethylmethyl nitroxide.

The resin components from Examples 1 (A-1) and 2 (A-2) as well as the hardener component (B) were mixed together in a 3:1 volume ratio, yielding mortar compositions.

### Determination of the Pot Life of the Mortar Compositions

The pot life of the mortar compositions obtained in this way was determined at a temperature of 25° C. in a commercial apparatus (GELNORM® Gel Timer). The components were mixed and heated with thermal regulation in a silicone bath at 25° C. immediately after being mixed and the temperature of the sample was measured. The sample itself is in a test tube, which is placed in an air blanket, and lowered into a silicone bath for temperature regulation.

The temperature of the sample was plotted as a function of time. The analysis was performed according to DIN 16945, Sheet 1 and DIN 16916. Pot life is the time when a temperature rise of 10K is achieved, namely here from 25° C. to 35° C.

Results of the pot life determinations are listed in Table 1.

### Determination of the Composite Stresses at Failure

To determine the composite stresses at failure of the cured compound, threaded anchor rods M12, which were doweled into boreholes in concrete with a diameter of 14 mm and a borehole depth of 72 mm using the reactive resin mortar compositions of the examples and comparative examples. The average failure loads were determined by central extraction of the threaded anchor rods. Three threaded anchor rods were doweled into place in each case and their load values were determined after 24 hours of curing. The failure composite stresses (N/mm²) determined in this way are listed as the mean value in the following Table 1.

Various borehole conditions and/or curing conditions were tested as listed below.

| Test condition | Comment |
|---|---|
| Reference | Well-cleaned percussion-drilled borehole, curing at room |
| | temperature (+20° C.) |
| −10° C. | reference holes, setting and curing at an underground |
| | temperature of −10° C. |
| +40° C. | reference holes, setting and curing at an underground |
| | temperature of +40° C. |

Results of the load value determinations are also shown in Table 1.

TABLE 1
Results of the determination of the pot life and composite
stresses at failure.

| | | Example | | | |
|---|---|---|---|---|---|
| | | 1 | 2 | V1 | V2 |
| Pot life (25° C.) [min] | | 5:30 | 7:15 | 5:00 | 6:00 |
| Composite stress at failure | −10° C. | 15.4 | 12.3 | 19.5 | 18.2 |
| [N/mm²] | +20° C. | 15.9 | 15.5 | 20.9 | 21.0 |
| | +40° C. | 19.6 | 19.3 | 21.5 | 22.9 |

It is apparent from this table that it is possible with 1-(diethoxyphosphinyl)-2,2-dimethylpropyl-1,1-dimethylmethyl nitroxide to adjust the pot life of a mortar composition in a targeted manner. In addition, it has been shown that the composite stresses at failure are within the range of those of mortar compositions at 40° C., the pot life of such a mortar composition being set at 5:00 min or 6:00 min using the known inhibitors 4-hydroxy-2,2,6,6-tetramethylpiperidine-N-oxyl and 2,6-di-tert-butyl-p-cresol. Under reference conditions, as well as at low temperatures (−10° C.), the composite stresses at failure are somewhat lower than those of the mortar compounds, whose pot life was adjusted with the known inhibitors mentioned above but are within a good, acceptable range and are characterized by a comparatively low dependence on temperature.

In storage, the same influence of oxygen on the pot life stability of the reactive resin mortars inhibited with 1-(diethoxyphosphinyl)-2,2-dimethylpropyl-1,1-dimethylmethyl nitroxide was also observed in the reactive resin mortars inhibited with 4-hydroxy-2,2,6,6-tetramethylpiperidine-N-oxyl. This means that reactive resin mortars according to the invention, when stored in the absence of oxygen, exhibit a gel time drift, whereas reactive resin mortars according to the invention stored in the presence of oxygen do not.

It has thus been shown that it is possible with the β-phosphorylated nitroxide radicals to reliably adjust the pot life.

1. A method of adjusting the reactivity and the pot life for a resin mixture or a reactive resin mortor, comprising the use of a β-phosphorylated nitroxide radical as the agent for adjusting the reactivity and the pot life for a resin mixture or a reactive resin mortar, based on radically curable compounds, wherein the β-phosphorylated nitroxide radical is selected from compounds of general formula (I) 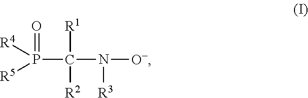
wherein
R¹ and R² may be the same or different and each denotes a hydrogen atom, a linear, branched, or cyclic C₁-C₁₀ alkyl group, an aryl group, or a C₁-C₁₀ aralkyl group; or R¹ and R² are linked together so that they form a ring with the carbon atom carrying the radicals R¹ and R², also having 3 to 8 carbon atoms including the carbon atom carrying the radicals R¹ and R²;
R³ denotes a linear or branched, saturated or unsaturated C₁-C₃₀ hydrocarbon group, optionally containing at least one ring; and
R⁴ and R⁵ may be the same or different and each denotes a linear or branched C₁-C₂₀ alkyl, cycloalkyl, aryl, alkoxy, aryloxy, aralkyloxy, perfluoroalkyl, aralkyl, dialkyl or diarylamino, alkylarylamino or thioalkyl groups; or
R⁴ and R⁵ are linked together so that with the phosphorus atom they form a ring having 2 to 4 carbon atoms and may also contain one or more additional oxygen, sulfur, or nitrogen atoms.

2. The method according to claim 1, wherein the β-phosphorylated nitroxide radical is selected from compounds of the general formula (II) 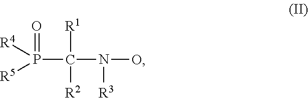
wherein
R¹ and R³ are defined as given above;
R⁴ and R⁵ may be the same or different and denote an alkoxy, aryloxy or aralkyloxy group.

3. The method according to claim 2, wherein R¹ and R³ may be the same or different and denote a branched or cyclic C₄-C₁₀ alkyl group, and R⁴ and R⁵ may be the same or different and denote a C₁-C₄ alkoxy group.

4. The method according to claim 3, wherein R¹ and R³ denote a tert-butyl group and R⁴ and R⁵ denote an ethoxy group.

5. The method according to claim 1, wherein the radically curable compound is obtained by reacting di- and/or higher functional isocyanates with suitable acryl compounds, optionally with the participation of hydroxy compounds containing at least two hydroxyl groups each.

6. The method according to claim 1, wherein the reactive resin mortar contains at least one inorganic additive, selected from the group consisting of fillers, thickeners, thixotropy agents, nonreactive solvents, agents to improve flowability and/or wetting agents.

7. The method according to claim 6, wherein the at least one inorganic additive is cement and/or quartz sand.

8. A resin mixture comprising at least one radically curable compound, at least one reactive diluent, optionally a stabilizer and an agent for adjusting the reactivity and the pot life wherein the agent is a stable β-phosphorylated nitroxide radical which is selected from compounds of the general formula (I) 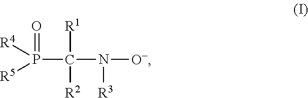
in which
R¹ and R² may be the same or different and each denotes a hydrogen atom, a linear, branched or cyclic C₁-C₁₀ alkyl group, an aryl group or a C₁-C₁₀ aralkyl group; or
R¹ and R² are linked together so that they form a ring with the carbon atom carrying the radicals R¹ and R², also having 3 to 8 carbon atoms including the carbon atom carrying the radicals R¹ and R²;
R³ denotes a linear or branched, saturated or unsaturated C₁-C₃₀ hydrocarbon group, optionally containing at least one ring; and
R⁴ and R⁵ may be the same or different and each denotes a linear or branched C₁-C₃₀ alkyl, cycloalkyl, aryl, alkoxy, aryloxy, aralkyloxy, perfluoroalkyl, aralkyl, dialkyl or diarylamino, alkylarylamino, or thioalkyl groups; or
R⁴ and R⁵ are linked together so that with the phosphorus atom they form a ring having 2 to 4 carbon atoms
and may also contain one or more additional oxygen, sulfur, or nitrogen atoms.

9. The resin mixture according to claim 8, wherein the β-phosphorylated nitroxide radical is selected from compounds of general formula (II) 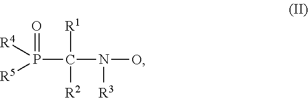
wherein
R¹ and R³ are defined as above;
R⁴ and R⁵ may be the same or different and denote an alkoxy, aryloxy, or aralkyloxy group.

10. The resin mixture according to claim 9, wherein R¹ and R³ may be the same or different and denote a branched or cyclic C₄-C₁₀ alkyl group and R⁴ and R⁵ may be the same or different and denote a C₁-C₄ alkoxy group.

11. The resin mixture according to claim 10, wherein R¹ and R³ denote a tert-butyl group and R⁴ and R⁵ denote an ethoxy group.

12. The resin mixture according to claim 11, wherein the β-phosphorylated nitroxide radical is present in an amount of 0.1 to 3 wt %, based on the resin mixture.

13. The resin mixture according to claim 8, wherein the radically polymerizable compound is obtained by reaction of di- and/or higher functional isocyanate with suitable acryl compounds, optionally with the participation of hydroxy compounds containing at least two hydroxyl groups.

14. The resin mixture according to claim 8, which also contains at least one accelerator for curing the radically curable compound.

15. A reactive resin mortar containing a resin mixture according to claim 8.

16. The reactive resin mortar according to claim 8, containing at least one inorganic additive selected from the group consisting of fillers, thickeners, thixotropy agents, nonreactive solvents, agents to improve flowability and wetting agents.

17. The reactive resin mortar according to claim 16, wherein the at least one inorganic additive is cement and/or quartz sand.

18. A multicomponent mortar system containing as the A component the reactive resin mortar according to claim 16 and as the B component a hardener for the radically curable compound.

19. The multicomponent mortar system according to claim 18, wherein the A component additionally contains a hydraulically setting or polycondensable inorganic compound in addition to the reactive resin mortar, and the B component also contains water in addition to the hardener.

20. A method of chemical fastening comprising using the multicomponent mortar system according to claim 18 as a binder for chemical fastening.

21. A capsule, cartridge, or film bag comprising the multicomponent mortar system according to claim 18, wherein they comprise two or more
separate chambers in which the reactive resin mortar and/or hardener is/are situated.
